(19) United States
(12) Patent Application Publication
(10) Pub. No.: US 2026/0202016 A1
(43) Pub. Date: Jul. 16, 2026

(54) WALL OF A TANK FOR STORING A FLUID AND METHOD FOR MOUNTING SUCH A WALL

(71) Applicant: GAZTRANSPORT ET TECHNIGAZ, Saint Remy Les Chevreuse (FR)

(72) Inventors: Edouard DUCLOY, Saint Remy Les Chevreuse (FR); Thibault LAURENT, Saint Remy Les Chevreuse (FR); Benjamin FAUBRY, Saint Remy Les Chevreuse (FR); Marie TIRVAUDEY, Saint Remy Les Chevreuse (FR); Laurine SENSEBY, Saint Remy Les Chevreuse (FR); Bruno DELETRE, Saint Remy Les Chevreuse (FR)

(73) Assignee: GAZTRANSPORT ET TECHNIGAZ, Saint Remy Les Chevreuse (FR)

(21) Appl. No.: 19/137,914

(22) PCT Filed: Dec. 1, 2023
(86) PCT No.: PCT/FR2023/051891

§ 371 Date: Jun. 11, 2025

(30) Foreign Application Priority Data
Dec. 20, 2022 (FR) FR2213968

(51) Int. Cl. F17C 3/02; F17C 13/00

(52) U.S. Cl. CPC F17C 3/027; F17C 13/001; F17C 2201/0147; F17C 2203/0358

(57) ABSTRACT

A wall of a tank for storing at least one fluid, the wall includes a shell and at least one panel kept at a distance from the shell by at least one anchoring element holding the panel relative to the shell by defining an area between the shell and the panel, the area being at least partially filled with a filling material, the wall includes a sealing membrane bearing against the panel arranged opposite the filling material relative to the panel.

This invention relates to the field of walls with surface irregularities requiring levelling, and more particularly to the wall of a tank for storing fluid.

The fluids from the oil industry, such as gas or refined oil, are generally stored in tanks. The storage of such fluids may, for example, be necessary to ensure the transport of fluids by land on lorries or by sea on ships. In other situations, these fluids may, for example, be stored permanently as a reserve or temporarily for distribution as in a service station.

Tanks, particularly made of concrete, are known to be manufactured and buried underground to form fluid storage areas. However, these tanks deteriorate over time as the concrete in them crumbles. Damage to the shell of the tank in this way leads to leaks which, in the case of the storage of fluids from the oil industry, may cause an environmental damage, particularly a soil pollution.

When leaks arc detected or the risk of leaks appears too high, it is known to repair or reinforce the shell, for example by attaching panels against the shell to ensure the sealing of the tank. These panels are pressed against the shell to be repaired using mastic. However, such a method is not suitable when the surface of the shell to be repaired has surface irregularities with an amplitude greater than 40 mm.

Against this background, the present invention provides a new means of sealing a defective shell by providing a new leakproof tank wall, even if the shell to be repaired comprises surface irregularities of an amplitude greater than 40 mm.

Thus, the present invention relates to a wall of a tank for storing at least one fluid, the wall comprising a shell and at least one panel kept at a distance from the shell by at least one anchoring element which holds the panel relative to the shell by delimiting an area between the shell and the panel, the arca being at least partly filled with a filling material, the wall comprising a sealing membrane bearing against the panel and being arranged opposite the filling material relative to the panel.

The wall comprises a shell that may be made of concrete, metal or a combination of concrete and metal. This shell has a face facing the inside of the tank, to which the at least one anchoring element is attached. This anchoring element supports a panel and, more specifically, keeps it at a distance from the shell by defining a space between the shell and the panel. It is understood that the panel comprises a face facing the shell and a face facing the inside of the tank. The area is delimited between the face of the shell facing the inside of the tank and the face of the panel facing the shell.

The filling material that at least partially fills said area provides a certain mechanical resistance, in combination with the anchoring elements, against the compressive stresses that the fluid contained in the tank may exert against the wall of the tank.

The shell comprises surface irregularities with an amplitude greater than 40 mm. It is understood here that the surface of the shell has a succession of projections and recesses whose distance between at least one bottom of the recess and a top of a projection adjacent to each other is greater than 40 mm. This distance, which defines the amplitude of the surface irregularities, is measured parallel to the shortest segment passing through the center of the tank delimited at least in part by the wall and by the surface irregularity.

In addition, the sealing membrane bearing against the panel makes the wall of the tank watertight. In other words, the sealing membrane prevents the fluid contained in the tank from reaching the shell of the area.

It is understood from the above that the panel used to delimit the area acts as a formwork element allowing, on the one hand, the filling material to be deposited between the shell and the panel and, on the other hand, the sealing membrane to be supported against said panel, i.e. pressed against the panel.

According to one characteristic of the invention, the wall comprises a sealed layer arranged between the shell and the filling material. This sealed layer at least limits the penetration of fluid through the face of the shell facing the outside of the tank. It is understood that the sealed layer is in contact with the filling material. Furthermore, it is understood that said filling material is contained between the panel and the sealed layer. Such a layer is a film that prevents rising from the outside of the shell towards the inside.

According to a characteristic of the invention, the panel kept at a distance from the shell is a secondary panel, the wall comprising a primary panel bearing against the sealing membrane.

According to a characteristic of the invention, the sealing membrane bearing against the panel is a secondary sealing membrane, the wall comprising a primary sealing membrane bearing against the primary panel.

It is understood that the wall is formed by at least one panel on which a sealing membrane bears. In this case, the wall comprises two panels and two sealing membranes. More specifically, the wall comprises a secondary panel on which a secondary sealing membrane bears with a primary panel against the secondary sealing membrane on which a primary sealing membrane bears. This superimposition of elements gives the wall a double seal in the event of a leak in one of the sealing membranes.

According to one characteristic of the invention, the filling material comprises at least in part a synthetic foam. According to one example, the synthetic foam is an expanding foam, i.e. a foam whose volume increases after being injected.

One characteristic of the invention is that the synthetic foam is thermally insulating.

According to one characteristic of the invention, the filling material comprises at least in part a particle-filled resin. The advantage of this type of resin is that it retains a substantially identical volume when the filling material is poured. A filling material made from a particle-filled resin also has a higher mechanical strength than expanding foams. By increasing the level of particulate filler within the resin, it is possible to reduce the quantity of resin required and thus limit the cost of the filling material used.

According to one characteristic of the invention, the sealing membrane comprises at least a first plate and a second plate, the first plate extending in a plane secant to a plane wherein the second plate extends, the sealing membrane comprising a membrane bridge which connects in a sealed manner the first plate and the second plate. It is understood that the primary sealing membrane, like the secondary sealing membrane, is formed by a succession of plates bearing against a panel. Advantageously, this shape taken by the primary and secondary sealing membranes allows them to follow the shape of the tank, particularly when the tank is a cylindrical tank.

According to an optional characteristic of the invention, the membrane bridge comprises at least one corrugation. This corrugation of the membrane bridge allows the membrane equipped with it to withstand deformation stresses, particularly as a result of the expansion of the wall or contraction of the latter under the thermal effects of the fluid stored in the tank. According to one example, at least one plate of the sealing membrane, and advantageously each of the plates of the sealing membrane, is entirely flat, i.e. devoid of any corrugation or undulation similar to that which the membrane bridge comprises.

It should be noted that, alternatively, said planes may be merged, particularly in the case where the tank has a cubic shape within which the shell comprises flat sides.

The present invention also relates to a method for mounting a wall of a tank for storing at least one fluid implementing:
at least one first step during which anchoring elements are secured to the shell,
at least one second step during which the at least one panel is made secured to the shell by means of the anchoring elements,
at least a third step during which the filling material is placed in the area delimited between the shell and the panel.

It is understood that the second step of the mounting method is a formwork step. This formwork step allows to delimit the area configured to receive the filling material, said area being delimited by at least the shell and the at least one panel.

It should be noted that “arranged” means that the filling material is cast or injected, for example, between the face of the shell facing the inside of the tank and the face of the panel facing the shell.

According to a characteristic of the invention, the mounting method implements a step prior to the first step during which the shell is analyzed to measure the surface irregularities of said shell, the anchoring elements being arranged so as to correct the surface irregularities measured during this step prior to the first step.

This analysis of the shell allows the surface irregularities of said shell to be corrected. It is understood that in the case where the present invention is used on a shell that has undergone alterations on its surface, the analysis of said surface of the shell allows the anchoring elements to be positioned so as to level the panels.

According to one characteristic of the invention, the mounting method is implemented when the surface irregularities of the shell are greater than 40 mm. This distance is measured between two circles, the center of which corresponds to the center of the tank. A first circle passes through a point on the shell furthest from the center of the tank and a second circle passes through a point closest to the center of the tank. The distance is measured along a radius of these circles, between these two circles.

It should be noted that the present invention may be implemented with a tank with flat walls, for example a square or rectangular tank. In this case, the surface irregularities are measured between a first plane passing through a point on the shell furthest from the center of the tank and a second plane passing through a point closest to the center of the tank. The distance of a surface irregularity is then a segment separating these two planes, measured perpendicular to the first and/or second plane.

According to a characteristic of the invention, the mounting method comprises a step prior to the first step during which the sealed layer is placed against the shell of the tank. For example, such a layer is sprayed to form a film, for example of a resin.

Where the wall comprises a plurality of panels, the mounting method during which the first step and the second step are repeated so as to arrange the panels side by side to form a ring of panels. It is understood that the third step of the mounting method is implemented once the ring of panels has been formed. In other words, once the ring of panels has been formed, the filling material is placed between the shell and the panels and a new ring of panels is formed.

In accordance with a characteristic of the invention, the mounting method comprises a fourth step during which the first plate is made secured to a panel and the second plate is made secured to an adjacent panel, the mounting method implementing a fifth step during which the membrane bridge is made secured in a sealed manner to the first plate and the second plate.

Other characteristics, details and advantages of the invention will become clearer on reading the following description, on the one hand, and examples of embodiments given by way of indication and non-limitation with reference to the attached schematic drawings, on the other hand, on which:

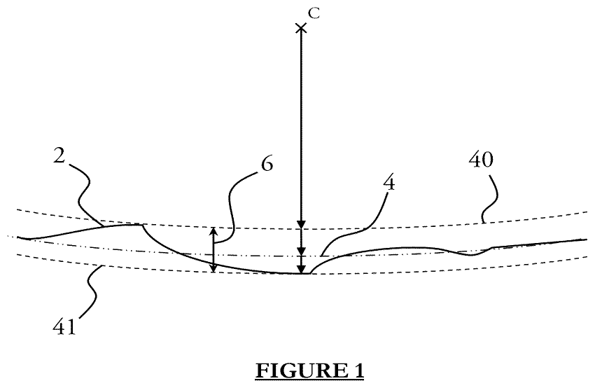

FIG. 1 shows a schematic view of a profile of one face of a shell facing the inside of a tank;

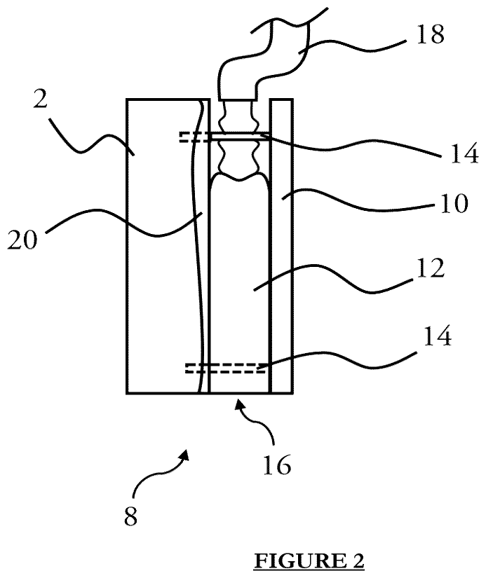

FIG. 2 shows a cross-sectional view of a wall according to the invention;

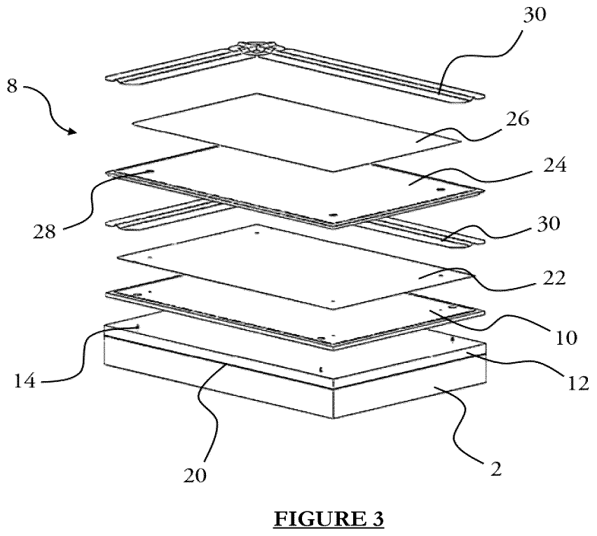

FIG. 3 shows an exploded view of the wall in one embodiment of the invention;

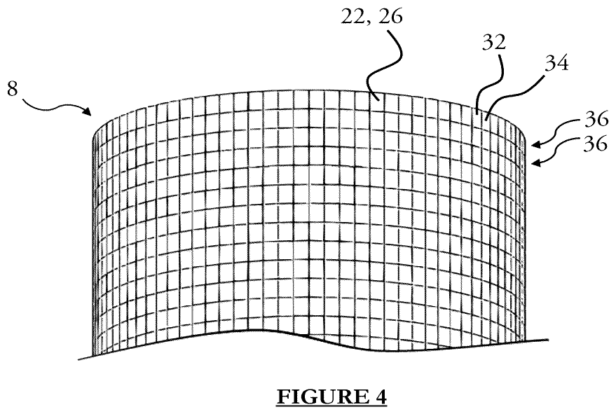

FIG. 4 shows a view illustrating the juxtaposition and the superposition of the panels forming the wall according to the invention;

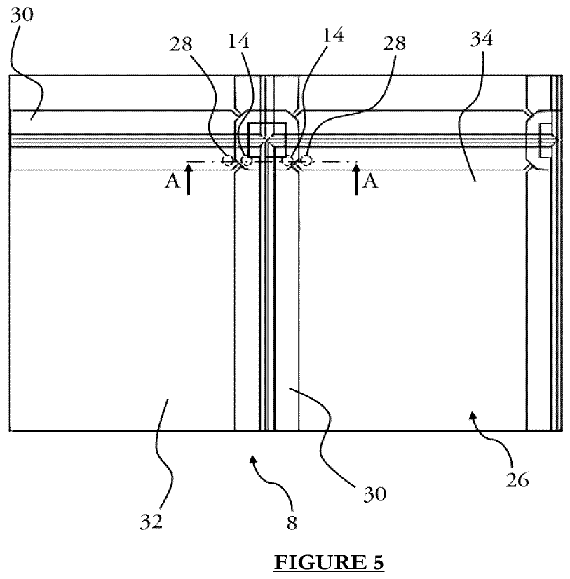

FIG. 5 shows a view of the wall according to the invention from inside the tank;

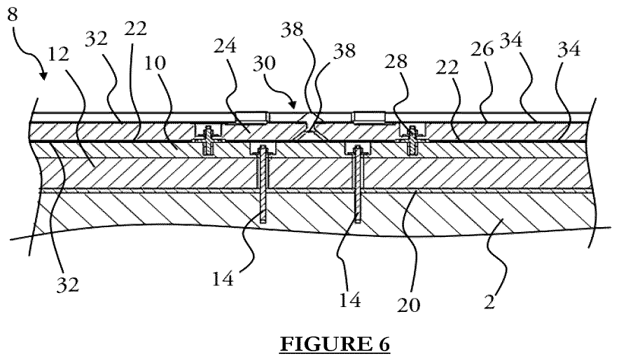

FIG. 6 shows a sectional view of the wall illustrated in FIG. 5.

First of all, it should be noted that although the figures set out the invention in detail for its implementation, these figures may of course be used to better define the invention, if necessary. It should also be noted that these figures only show examples of embodiments of the invention.

The characteristics, the variants and the different embodiments of the invention may be associated with one another in various combinations, insofar as they are not incompatible or mutually exclusive. In particular, it will be possible to imagine variants of the invention comprising only a selection of characteristics described hereinafter in isolation from the other characteristics described, if this selection of characteristics is sufficient to confer a technical advantage or to differentiate the invention from the prior art.

In the figures, the elements common to several figures retain the same reference. In addition, the elements hidden behind other elements appear as dotted lines.

FIG. 1 is a very schematic representation of the shell 2 of a tank for storing at least one fluid to which the present invention may be applied. In particular, FIG. 1 shows the profile of one face of the shell 2 facing the inside of the tank. It should be noted that in the embodiment shown and without limiting the invention, the fluid stored in the tank is a fluid in the liquid state from the petroleum industry, such as refined petroleum or “LNG”, an acronym for liquefied natural gas.

The shell 2 of the tank has surface irregularities relative to a reference profile 4 representing a median surface of the shell 2 of the tank.

The surface irregularities present on the shell 2 are distinguished by portions of said face of the shell 2 that deviate from the reference profile 4. Some of the distances between said face of the shell 2 and the reference profile 4 are, in the embodiment shown, greater than 40 mm. Thus, as may be seen in FIG. 1, certain surface irregularities of the shell 2, such as the surface irregularity represented by a double arrow 6, are greater than 40 mm. It should be noted that this distance measured from the surface irregularities, and represented by the double arrow 6, corresponds to the distance separating a first circle 40 passing through the top of an irregularity from a second circle 41 passing through the bottom of an irregularity. This distance is measured along the radius of either of these circles. FIG. 1 is intended to illustrate the irregularities that the invention may handle, but the shapes or positions illustrated here are given by way of example only.

FIG. 2 shows schematically a local view of the shell 2 wherein the surface irregularities of the shell 2 are corrected so that a sealing structure may be installed on the face of the shell 2 facing the inside of the tank.

More specifically, FIG. 2 shows the mounting of a wall 8 according to the invention. This wall 8 comprises at least the shell 2, a panel 10 and a sealing membrane bearing against the panel 10. A filling material 12 is placed between the shell 2 and the panel 10, with the panel 10 installed on the side of the shell 2 facing the inside of the tank. The sealing membrane, which will be described in more detail in relation to FIG. 3, is arranged opposite the filling material 12 with respect to the panel 10.

During the mounting of the wall 8, anchoring elements 14 are secured to the shell 2, for example by being inserted into it. The panel 10 is positioned on these anchoring elements 14 so as to be held at a distance from the shell 2 by means of said anchoring elements 14. This distance separating the panel 10 from the shell 2 is at least 40 mm, but the invention is aimed at a distance of between 40 mm and 250 mm.

As may be seen in FIG. 2 or 6, the panel 10 is more specifically positioned on a head of said anchoring elements 14, opposite the part of the anchoring elements 14 housed in the shell 2. Each head of the anchoring elements 14, supporting the same panel 10, is advantageously located at a distance from the shell 2 so as to reconstitute a profile close to the first circle 40 mentioned above.

The positioning of the panel 10 on the heads of the anchoring elements 14 creates an area 16 between the panel 10 and the shell 2. The area 16 is then at least partially filled with the filling material 12. In the embodiment shown, the filling material 12 is at least partly formed from a synthetic foam poured or injected into the area 16 via a supply pipe 18. The panel 10 forms a structural element arranged directly opposite the shell 2. This configuration allows the panel 10 to delimit the area 16 between the shell 2 and the panel 10.

It should be noted that in this embodiment, the filling material is advantageously thermally insulating, which is advantageous when the tank contains, for example, LNG, ammonia, LPG and, in general, any fluid kept in the liquid state at a temperature below −50° C. at atmospheric pressure.

In an alternative or complementary embodiment, the filling material 12 is at least partly formed from a particle-filled resin. This resin may, by way of illustrative and non-limiting examples of the invention, be an epoxy resin, a vinyl ester resin, a polyester resin or a polyurethane resin. Within this resin, the particles making up the filler are preferably glass beads or hollow glass beads. By way of illustrative and non-limiting examples of the invention, the particles making up the resin filler may be clay, sand or vermiculite beads, or recycled particles from, for example, crushed concrete, tires or composites. Such particle-filled resins have a substantially equal volume when the filling material 12 is poured. The filling material 12 is poured at an angle between the shell 2 and several panels 10. As a result, there is angular continuity of the filling material 12 over several adjacent panels 10. This angular continuity is remarkable for the absence of a cut in the filling material 12 at the junction between two juxtaposed panels 10.

In addition, the wall 8 also comprises a sealed layer 20 arranged between the shell 2 and the filling material 12. More specifically, this sealed layer 20 is, in the embodiment shown, pressed against the shell 2 and allows to at least limit the penetration of fluids from outside the tank, such as water.

It is understood from the above that the invention implements a mounting method during which the anchoring elements 14 are secured to the shell 2 during a first step. Then, in a second step, the panel 10 is secured to the shell 2 by means of the anchoring elements 14. The filling material 12 is then placed in the area 16 between the shell 2 and the panel 10.

It should be noted that the method for mounting the wall 8 also implements a step prior to the first step. This step prior to the first step allows the anchoring elements 14 to be positioned, as previously mentioned, so as to reconstitute the profile of the first circle 40. More specifically, during this step prior to the first step, the face of the shell 2 facing the inside of the tank is analyzed to measure the surface irregularities of the shell 2. This analysis of the shell 2 may, by way of an illustrative and non-limiting example, be carried out using a laser analysis recognition device connected to a computer modelling device. This analysis of the face of the shell 2 facing the inside of the tank allows the anchoring elements 14 to be positioned during the first step and adjusted to correct the surface irregularities. Such an adjustment may, for example, result from anchoring elements of different lengths. This adjustment may also be made by inserting the anchoring element more or less into the shell 2.

It should also be noted that the method for mounting the wall 8 also implements another, earlier step wherein the sealed layer 20 is sprayed against the shell 2 of the tank. It is understood that this step is preferably and if necessary, implemented after the step of analyzing the face of the shell 2 facing the inside of the tank, so as to allow an optimum analysis of the shell 2.

FIG. 3 shows the structure of the wall 8 in one embodiment of the invention. As may be seen in this figure, the panel 10, which is held at a distance from the shell 2 by the anchoring elements 14 and on which the sealing membrane 22 bears, is a secondary panel 10. The wall 8 also comprises a primary panel 24 that bears against the sealing membrane 22. It should also be noted that, in the embodiment shown, said sealing membrane 22 is a secondary sealing membrane 22. The wall 8 also comprises a primary sealing membrane 26 that bears against the primary panel 24.

According to the embodiment shown in FIG. 3, the wall 8 comprises, in succession from the shell 2 towards the inside of the tank, the sealed layer 20, the filling material 12, the secondary panel 10, the secondary sealing membrane 22, the primary panel 24 and the primary sealing membrane 26.

The sealing membrane 22 or secondary sealing membrane 22 comprises at least a first plate and a second plate. In the embodiment shown in FIG. 3, only one of the two aforementioned plates is shown. The secondary sealing membrane 22 also comprises a membrane bridge 30 for connecting in a sealed manner the first plate and the second plate. Note that this membrane bridge 30 will be described in more detail in relation to FIGS. 4, 5 and 6.

The primary sealing membrane 26 comprises at least a first plate and a second plate. In the embodiment shown in FIG. 3, only one of the two aforementioned plates is shown. The primary sealing membrane 26 also comprises a membrane bridge 30 for connecting in a sealed manner the first plate and the second plate. Note that this membrane bridge 30 will be described in more detail in relation to FIGS. 4, 5 and 6.

FIG. 4 shows schematically the wall 8 of a tank for storing a fluid in accordance with the invention. It should be noted that in this FIG. 4, the shell 2, the sealed layer 20, the filling material 12 and the secondary panel 10 are not shown, leaving only the sealing membrane 22, 26 visible. In other words, the visible face of the sealing membrane 22, 26 is the face configured to bear against the secondary panel 10. It should also be noted that in the embodiment shown in FIG. 4, the tank is circular in shape. Of course, without going beyond the scope of the invention, the tank may have other shapes, in particular a parallelepiped or cubic shape.

As previously mentioned, the sealing membrane 22, 26 comprises a first plate 32 and a second plate 34. This first plate 32 is flat and extends in a plane secant to a plane wherein the second plate 34 extends, the latter also being flat. The membrane bridge 30 provides a sealed junction between the first plate 32 and the second plate 34.

FIG. 4 also highlights a characteristic of the method for mounting the wall 8. The first and second steps of the mounting method are repeated so that the panels are arranged side by side to form a ring 36 of panels.

It is understood that each panel 10 is positioned next to another panel 10 to form a ring 36 of panels. The panels 10 are also superimposed on top of each other so that the panel rings 36 are also superimposed on top of each other and line the shell 2.

FIG. 5 shows a view of the wall 8 and more particularly of the primary sealing membrane 26 bearing against the primary panel 24. As shown in FIG. 5, the primary sealing membrane 26 is secured to the primary panel 24 by means of stud 28. This stud 28 holds the primary sealing membrane 26 against the primary panel 24.

FIG. 5 also highlights a fourth step and a fifth step in the method for mounting the wall 8. During the fourth step of the mounting method, the first plate 32 is secured to one panel, in this case the primary panel 24, and the second plate 34 is secured to another adjacent panel, in this case another primary panel 24. In a fifth step of the method for mounting the wall 8, the membrane bridge is secured in a sealed manner to the first plate 32 and the second plate 34. This may be achieved by welding an edge of the membrane bridge 30 to a face of the plate against which the membrane bridge 30 is pressed.

It should be noted that what has just been described in relation to the primary sealing membrane 26 applies mutatis mutandis to the secondary sealing membrane 22. In other words, the secondary sealing membrane 22 is formed, like the primary sealing membrane 26, of a first plate 32 secured in this case to a primary panel 10, and of a second plate 34 secured to another adjacent primary panel 10, a membrane bridge 30 being secured in a sealed manner to said first plate 32 and to said second plate 34.

FIG. 6 shows a cross-sectional view of the wall 8 along a section A-A, as seen in FIG. 5. FIG. 6 shows more clearly the superposition of the various elements forming the wall 8. Specifically, FIG. 6 shows a corrugation 38 in the membrane bridge 30. This corrugation 38 of the membrane bridge 30 allows the membrane of which it forms part to deform under the various stresses to which the tank is subjected, in particular the stresses of expansion or contraction of the wall 8 under the effect of the temperature of the fluid that may be stored in the tank.

In one example, the membrane bridge 30 comprises two straight corrugations 38 arranged at right angles to each other. The membrane bridge 30 may then be made in one piece, but it will be advantageous to make it from two straight portions, perpendicular to each other and joined by a knot.

In addition, the membrane bridge 30 is secured to the first plate 32 and the second plate 34 of the same sealing membrane 22, 26 by means of a weld. To this end, the membrane bridge 30 comprises a clinched portion on either side of the corrugation 38, which extends above the plane of the first plate 32 and of the second plate 34. In this way, the membrane bridge 30 is secured in a sealed manner to the first plate 32 and the second plate 34.

FIG. 6 also shows that the corrugation 38 of the membrane bridge 30 forming the primary sealing membrane is above the corrugation 38 of the membrane bridge forming the secondary sealing membrane.

FIG. 6 shows that the primary panel 24 is held bearing against the secondary panel 10 by a stud 28. To accommodate the latter, the primary panel 24 comprises at least one counterbore to accommodate a tightening nut. The stud 28 comprises a collar which is welded in a sealed manner to the secondary sealing membrane 22.

The panel 10 also comprises a counterbore which receives the head of the anchoring element 14, such counterbore being covered by the sealing membrane which is pressed against the panel 10.

The present invention achieves its intended purpose by proposing a wall of a tank wherein alterations to the shell have been corrected by means of a panel kept at a distance from the shell by anchoring elements and with at least one sealing membrane bears against this panel. The mechanical stresses applied to the wall are taken up by the filling material once it has solidified. Such a material is advantageously thermally insulating.

1. A wall of a tank for storing at least one fluid, the wall comprising a shell comprising surface irregularities of an amplitude greater than 40 mm and at least one panel kept at a distance from the shell by at least one anchoring element which holds the panel relative to the shell by delimiting an area between the shell and the panel, the area being at least partly filled with a filling material, the wall comprising a sealing membrane bearing against the panel and being arranged opposite the filling material relative to the panel.

2. The wall according to claim 1, comprising a sealed layer arranged between the shell and the filling material.

3. The wall according to claim 1, wherein the panel kept at a distance from the shell is a secondary panel, the wall comprising a primary panel bearing against the sealing membrane.

4. The wall according to claim 3, wherein the sealing membrane bearing against the panel is a secondary sealing membrane, the wall comprising a primary sealing membrane bearing against the primary panel.

5. The wall according to claim 1, wherein the filling material comprises at least in part a synthetic foam.

6. The wall according to claim 5, wherein the synthetic foam is thermally insulating.

7. The wall according to claim 1, wherein the filling material comprises at least in part a particle-filled resin.

8. The wall according to claim 1, wherein the sealing membrane comprises at least a first plate and a second plate, the first plate extending in a plane secant to a plane wherein the second plate extends, the sealing membrane comprising a membrane bridge which connects in a sealed manner the first plate and the second plate.

9. The wall according to claim 8, wherein the membrane bridge comprises at least one corrugation.

10. A method for mounting a wall of a tank for storing at least one fluid according to claim 1, the mounting method implementing:
at least one first step during which anchoring elements are secured to the shell,
a step prior to the first step during which the shell is analyzed to measure the surface irregularities of said shell, the anchoring elements being arranged so as to correct the surface irregularities measured during this step prior to the first step,
at least one second step during which the at least one panel is made secured to the shell by means of the anchoring elements,
at least a third step during which the filling material is placed in the area delimited between the shell and the panel.

11. The mounting method according to claim 10, the method being implemented when the surface irregularities of the shell are greater than 40 mm.

12. The mounting method according to claim 10,
wherein a sealed layer is arranged between the shell and the filling material, and
further comprising a step prior to the first step during which the sealed layer is placed against the shell of the tank.

13. The mounting method according to claim 9, the wall comprising a plurality of panels, mounting method during which the first step and the second step are repeated so as to arrange the panels side by side to form a ring of panels.

14. The mounting method according to claim 10,
wherein the filling material comprises at least in part a particle-filled resin, and
the mounting method comprising a fourth step during which the first plate is made secured to a panel and the second plate is made secured to an adjacent panel, the mounting method implementing a fifth step during which the membrane bridge is made secured in a sealed manner to the first plate and the second plate.
